(19) United States
(12) Patent Application Publication
(10) Pub. No.: US 2026/0349286 A1
(43) Pub. Date: Nov. 5, 2026

(54) OPTICAL WAVEGUIDE HEATER

(71) Applicant: Taiwan Semiconductor Manufacturing Company, Ltd., Hsinchu (TW)

(72) Inventors: Yi Min Wang, Hsinchu (TW); Chia-Wei Chiang, Hsinchu County (TW); Shu-Wei Chang, Taipei City (TW); Chun-Pei Wu, Mingjian Township (TW); Lian Wee Luo, Hsinchu (TW); Chi-Yuan Shih, Hsinchu (TW); Tse-En Chang, Hsinchu City (TW); Shih-Fen Huang, Jhubei (TW)

(21) Appl. No.: 19/734,390

(22) Filed: Jul. 8, 2026

Related U.S. Application Data
(63) Continuation of application No. 18/792,634, filed on Aug. 2, 2024.

(51) Int. Cl. G02F 1/01

(52) U.S. Cl. CPC G02F 1/0147

(57) ABSTRACT

An integrated chip including a semiconductor waveguide layer. A core portion of the semiconductor waveguide layer protrudes upward from a base portion of the semiconductor waveguide layer. A first heat radiator is spaced over the semiconductor waveguide layer and laterally spaced from the core portion in a first direction. A second heat radiator is spaced over the semiconductor waveguide layer and laterally spaced from the core portion in a second direction. A first dielectric layer is between the first heat radiator and the semiconductor waveguide layer and between the second heat radiator and the semiconductor waveguide layer. A distance between the first heat radiator and the semiconductor waveguide layer is less than a distance between the first heat radiator and the core portion. A distance between the second heat radiator and the semiconductor waveguide layer is less than a distance between the second heat radiator and the core portion.

### REFERENCE TO RELATED APPLICATION

This Application is a Continuation of U.S. application Ser. No. 18/792,634, filed on Aug. 2, 2024, the contents of which are hereby incorporated by reference in their entirety.

### BACKGROUND

Optical waveguides are often used as components in integrated optical circuits. Optical waveguides are used to confine and guide light from a first point on an integrated chip (IC) to a second point on the IC with minimal attenuation. Many modern optical waveguides are formed using semiconductors. A semiconductor waveguide may include an optical converter or an optical coupler for optically coupling an optical fiber to the semiconductor waveguide.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a cross-sectional view of some embodiments of an integrated chip comprising a heater over a waveguide.

FIGS. 2-3 illustrate top views of some embodiments of the integrated chip of FIG. 1.

FIGS. 4-6 illustrate cross-sectional views of some other embodiments of the integrated chip of FIG. 1.

FIG. 7 illustrates a top view of some embodiments of an integrated chip comprising a heater over a waveguide in which the waveguide forms a ring modulator.

FIGS. 8-9 illustrate cross-sectional views of some embodiment of the integrated chip of FIG. 7.

FIGS. 10-11 illustrate cross-sectional views of some other embodiments of the integrated chip of FIGS. 7-9.

FIG. 12 illustrates a top view of some other embodiments of the integrated chip of FIG. 7.

FIGS. 13-14 illustrate cross-sectional views of some embodiments of the integrated chip of FIG. 12.

FIGS. 15-16 illustrate top views of some other embodiments of the integrated chip of FIG. 12.

FIG. 17 illustrates a cross-sectional view of some other embodiments of the integrated chips of FIGS. 1-16.

FIGS. 18-34 illustrate cross-sectional views of some embodiments of a method for forming an integrated chip comprising a heater over a waveguide.

FIG. 35 illustrates a flow diagram of some embodiments of a method for forming an integrated chip comprising a heater over a waveguide.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

An integrated chip includes a semiconductor waveguide layer over a substrate. A base portion of the semiconductor waveguide layer extends laterally over the substrate. A core portion of the semiconductor waveguide layer protrudes upward from the base portion and forms a core of a waveguide. Optical radiation signals travel through and are generally confined within the core portion of the semiconductor waveguide layer.

The performance of the waveguide can be affected by the temperature of the core portion of the semiconductor waveguide layer. For example, the temperature of the core portion can affect the refractive index of the core portion, which in turn can affect the phase and/or wavelength of the optical radiation signals traveling in the core portion. Thus, in some examples, a heater is spaced directly over the core portion of the semiconductor waveguide layer to control the temperature of the core portion. A dielectric layer is between the heater and the core portion. Heat emitted from the heater is transferred to the core portion of the semiconductor waveguide layer through the dielectric layer.

In some cases, the heater may cause optical radiation loss if the heater is too close to the core portion. Thus, the thickness of the dielectric layer between the heater and the core portion is increased to reduce a likelihood of the heater causing optical loss. However, because the dielectric layer has a relatively low thermal conductivity, increasing the thickness of the dielectric layer may increase a thermal resistance between the heater and the core portion. Consequently, the temperature of the heater may need to be increased to heat the core portion. Increasing the temperature of the heater increases the power consumption of the heater. Thus, a power efficiency of the heater may be reduced. Further, heating the heater to high temperatures may reduce the reliability of the integrated chip. For example, the dielectric layer and/or nearby interconnects may be damaged by the high heat emitted from the heater.

In various embodiments of the present disclosure, a lateral distance between the heater and the core portion is increased and a vertical distance between the heater and the semiconductor waveguide layer is reduced to improve the efficiency of the heater and the reliability of the integrated chip without increasing optical loss at the core portion. For example, the heater includes a first heat radiator laterally spaced from the core portion in a first direction and a second heat radiator laterally spaced from the core portion in a second direction. By laterally spacing the heat radiators from the core portion, the distance between the heater radiators and the core portion is increased to reduce a likelihood of causing optical loss in the core portion. Further, the thickness of the dielectric layer between the first and second heat radiators and the semiconductor waveguide layer is reduced to reduce the thermal resistance between the heat radiators and the core portion of the semiconductor waveguide layer. For example, heat emitted from the heat radiators is transferred to lateral portions (e.g., pickup portions) of the semiconductor waveguide layer that are under the heat radiators through the thin dielectric layer. By reducing the thickness of the dielectric layer, the thermal resistance between the heat radiators and the lateral portions of the semiconductor waveguide layer is reduced. The heat is then transferred from the lateral portions of the semiconductor waveguide layer to the core portion of the semiconductor waveguide layer through the base portion of the semiconductor waveguide layer. Because the thermal conductivity of the semiconductor waveguide layer is substantially greater than the thermal conductivity of the dielectric layer, the thermal resistance between the lateral portions of the semiconductor waveguide layer and the core portion of the semiconductor waveguide layer is low. Thus, the total thermal resistance between the heat radiators and the core portion of the semiconductor waveguide layer is reduced.

By reducing the thermal resistance between the heater and the core portion of the semiconductor waveguide layer, the temperature of the heater can be reduced. Reducing the temperature of the heater reduces the power consumption of the heater. Thus, a power efficiency of the heater can be improved. Further, by reducing the temperature of the heater, reliability issues caused by high heat at the heater can be reduced or avoided.

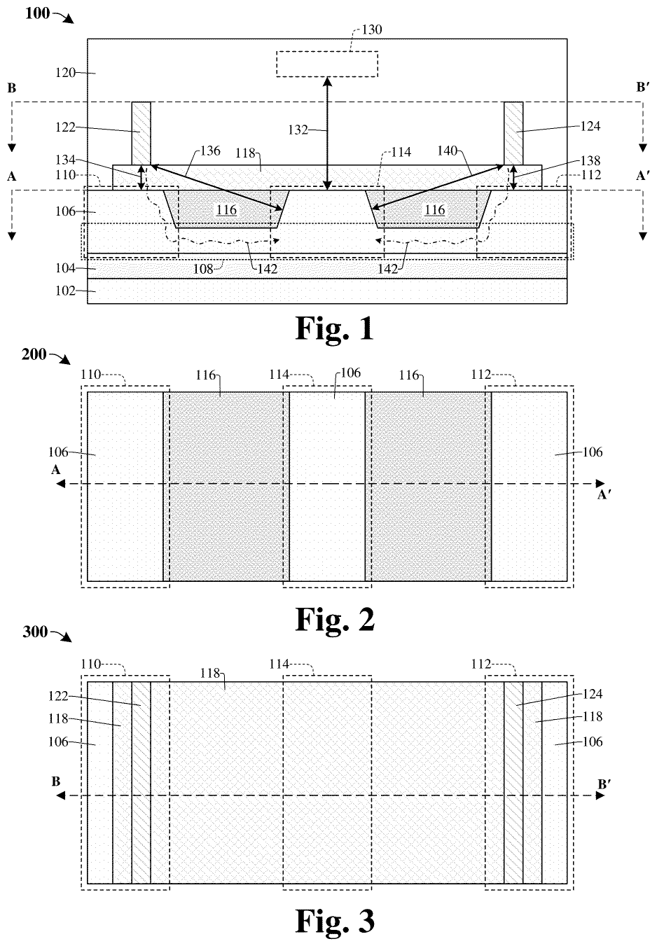

FIG. 1 illustrates a cross-sectional view 100 of some embodiments of an integrated chip comprising a heater over a waveguide. FIG. 2 illustrates a top view 200 and FIG. 3 illustrates a top view 300 of some embodiments of the integrated chip of FIG. 1. In some embodiments, top view 200 of FIG. 2 is taken across line A-A′ of FIG. 1 and top view 300 of FIG. 3 is taken across line B-B′ of FIG. 1.

A base dielectric layer 104 is over a base semiconductor layer 102. A semiconductor waveguide layer 106 is over the base dielectric layer 104. A base portion 108 of the semiconductor waveguide layer 106 extends laterally over the base dielectric layer 104. A first pickup portion 110, a second pickup portion 112, and a core portion 114 of the semiconductor waveguide layer 106 protrude upward from the base portion 108. The first pickup portion 110 is laterally spaced from the core portion 114 in a first direction and the second pickup portion 112 is laterally spaced from the core portion 114 in a second direction, opposite the first direction, so the core portion 114 is laterally spaced between the first pickup portion 110 and the second pickup portion 112.

A first dielectric layer 116 is over the base portion 108 and between core portion 114 and the pickup portions 110, 112. A second dielectric layer 118 (e.g., a resist protective dielectric layer) is over the semiconductor waveguide layer 106 and the first dielectric layer 116. The second dielectric layer 118 extends laterally along a top of the first pickup portion 110, a top of the core portion 114, and a top of the second pickup portion 112. A third dielectric layer 120 (e.g., an interlayer dielectric (ILD) layer) is over the semiconductor waveguide layer 106 and the second dielectric layer 118.

A heater is within the third dielectric layer 120 and spaced over the semiconductor waveguide layer 106. In some examples, the heater is spaced directly over the core portion 114, as illustrated by feature 130, which is shown in “phantom”. In such examples, the distance between the heater and the semiconductor waveguide layer 106 is the same as the distance between the heater and the core portion 114, as shown by distance 132. The distance between the heater and the core portion 114 is increased to avoid causing optical loss. Thus, the amount of dielectric (e.g., the combined thickness of dielectric layer 120 and dielectric layer 118) between the heater and the core portion 114 is increased. However, the second and third dielectric layers 118, 120 have reduced thermal conductivity. Thus, increasing the amount of dielectric between the heater and the core portion 114 increases the thermal resistance between the heater and the core portion 114.

In various embodiments of the present disclosure, the heater includes a first heat radiator 122 and a second heat radiator 124. The temperature of the heat radiators 122, 124 is increased by passing an electrical current through the heat radiators 122, 124. The electrical resistance of the heat radiators 122, 124 causes some of the electrical energy to be converted to thermal energy (heat). As the temperature of the heat radiators 122, 124 increases, heat is emitted from heat radiators 122, 124. The lateral distance between the heat radiators 122, 124 and the core portion 114 is increased and a vertical distance between the heat radiators 122, 124 and the semiconductor waveguide layer 106 is reduced to improve the efficiency of the heater and the reliability of the integrated chip without increasing optical loss at the core portion 114.

For example, the first heat radiator 122 is directly over the first pickup portion 110 and the second heat radiator 124 is directly over the second pickup portion 112. By laterally spacing the heat radiators 122, 124 from the core portion 114, the distance between the heater radiators 122, 124 and the core portion 114 is increased to reduce a likelihood of causing optical loss in the core portion 114. The heater radiators 122, 124 do not extend directly over the core portion 114 to avoid causing optical loss.

Further, the heat radiators 122, 124 are on the second dielectric layer 118 and are separated from the semiconductor waveguide layer 106 by the second dielectric layer 118. The thickness of the second dielectric layer 118 is reduced to reduce the thermal resistance between the heat radiators 122, 124 and the pickup portions 110, 112. For example, the thickness of the second dielectric layer 118 is reduced so that a distance 134 between the first heat radiator 122 and the semiconductor waveguide layer 106 (e.g., the first pickup portion 110) is less than a distance 136 between the first heat radiator 122 and the core portion 114, and a distance 138 between the second heat radiator 124 and the semiconductor waveguide layer 106 (e.g., the second pickup portion 112) is less than a distance 140 between the second heat radiator 124 and the core portion 114. Heat emitted from the heat radiators 122, 124 is transferred to the pickup portions 110, 112 through the thin second dielectric layer 118. The heat is then transferred from the pickup portions 110, 112, to the core portion 114 through the base portion 108, as illustrated by arrows 142. The thermal conductivity of the semiconductor waveguide layer 106 is substantially greater (e.g., about 10 times greater) than the thermal conductivity of the second and third dielectric layers 118, 120. Thus, the thermal resistance between the pickup portions 110, 112 and the core portion 114 is low. As a result, the total thermal resistance between the heat radiators 122, 124 and the core portion 114 of the semiconductor waveguide layer 106 is reduced.

By reducing the thermal resistance between the heater and the core portion 114 of the semiconductor waveguide layer 106, the temperature of the heater can be reduced. Reducing the temperature of the heater reduces the power consumption of the heater. Thus, a power efficiency of the heater can be improved. Further, by reducing the temperature of the heater, reliability issues caused by high heat at the heater can be reduced or avoided.

The core portion 114 is partially delimited by a pair of sidewalls and an upper surface of the semiconductor waveguide layer 106. The first pickup portion 110 is partially delimited by a sidewall and an upper surface of the semiconductor waveguide layer 106. The second pickup portion 112 is partially delimited by a sidewall an upper surface of the semiconductor waveguide layer 106. The base portion 108 is partially delimited by an upper surface of the semiconductor waveguide layer 106 that is between the core portion 114 and the first pickup portion 110 and an upper surface of the semiconductor waveguide layer 106 that is between the core portion 114 and the second pickup portion 112.

In some embodiments, the base semiconductor layer 102 and the base dielectric layer 104 are referred to as a substrate. In some embodiments, the base semiconductor layer 102, the base dielectric layer 104, and the semiconductor waveguide layer 106 are, or are part of, a semiconductor-on-insulator (SOI) substrate where the semiconductor waveguide layer 106 is the “device” layer of the SOI substrate.

In some embodiments, the base semiconductor layer 102 and/or the semiconductor waveguide layer 106 comprise silicon or some other suitable semiconductor. In some embodiments, the base dielectric layer 104, the first dielectric layer 116, and/or the third dielectric layer 120 comprise silicon dioxide or some other suitable dielectric. In some embodiments, the second dielectric layer 118 comprises silicon dioxide, silicon nitride, or some other suitable dielectric. In some embodiments, a thickness of the second dielectric layer 118 is less than about 500 nanometers, ranges from about 1 nanometer to 500 nanometers, or is some other suitable thickness. In some embodiments, the heat radiators 122, 124 comprise a metal (e.g., tungsten, titanium, copper, or the like), a semiconductor (e.g., doped or undoped polysilicon, doped or undoped silicon, or the like), a silicide, or some other suitable material. In some embodiments, the heat radiators 122, 124 are alternatively referred to as heater wires, heater structures, or heat emitting features.

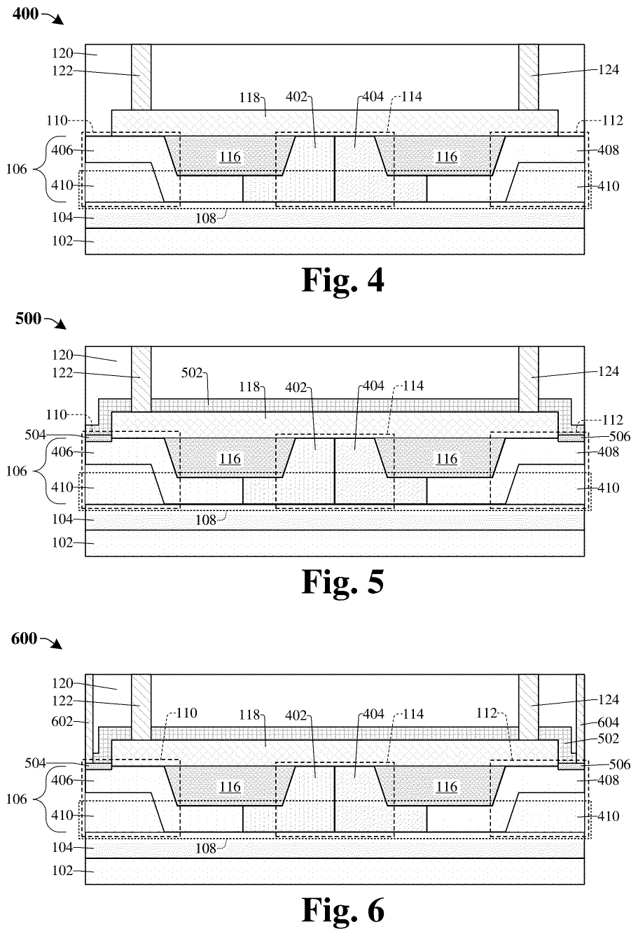

FIG. 4 illustrates a cross-sectional view 400 of some embodiments of the integrated chip of FIG. 1 in which the semiconductor waveguide layer 106 is doped.

The semiconductor waveguide layer 106 includes a first doped region 402 and a second doped region 404. The first doped region 402 and the second doped region 404 fill the core portion 114 of the semiconductor waveguide layer 106. The first doped region 402 abuts the second doped region 404 near a center of the core portion 114. The first doped region 402 extends laterally into the base portion 108 on a first side of the core portion 114 and the second doped portion 404 extends laterally into the base portion 108 on a second side of the core portion 114. The first doped region 402 has a first doping type (e.g., n type) and the second doped region 404 has a second doping type (e.g., p type) opposite the first doping type. The first doped region 402 and the second doped region 404 form a p-n junction within the core portion 114. The first and second doped regions 402, 404 have relatively low doping concentrations (e.g., n− and p− doping, respectively).

The semiconductor waveguide layer 106 includes a third doped region 406 and a fourth doped region 408. The third doped region 406 is in the first pickup portion 110 of the semiconductor waveguide layer 106 and extends laterally into the base portion 108 to the first doped region 402. The fourth doped region 408 is in the second pickup portion 112 of the semiconductor waveguide layer 106 and extends laterally into the base portion 108 to the second doped region 404. The third doped region 406 has the first doping type and the fourth doped region 408 has the second doping type. The first heat radiator 122 is directly over the third doped region 406 and the second heat radiator 124 is directly over the fourth doped region 408. The third and fourth doped regions 406, 408 have relatively high doping concentrations (e.g., n+ and p+ doping, respectively).

In some embodiments, the semiconductor waveguide layer 106 includes a bulk region 410 directly under the third doped region 406 and the fourth doped region 408. In some embodiments, the bulk region 410 is undoped (e.g., intrinsic). In some other embodiments, the bulk region 410 has the first doping type.

FIG. 5 illustrates a cross-sectional view 500 of some embodiments of the integrated chip of FIG. 1 in which an etch stop layer 502 over the second dielectric layer 118.

The etch stop layer 502 is between the second dielectric layer 118 and the third dielectric layer 120, and between the semiconductor waveguide layer 106 and the third dielectric layer 120. The etch stop layer 502 extends along a top surface of the second dielectric layer 118 and sidewall of the second dielectric layer 118. The heat radiators 122, 124 extend through the etch stop layer 502 to the second dielectric layer 118. In some embodiments, the etch stop layer 502 comprises silicon dioxide, silicon nitride, silicon carbide, aluminum oxide, or some other suitable material.

Silicide layers 504, 506 are between the semiconductor waveguide layer 106 and the etch stop layer 502 at the pickup portions 110, 112, respectively. The silicide layers 504, 506 extend into the semiconductor waveguide layer 106 (e.g., below tops of the semiconductor waveguide layer 106) and above the semiconductor waveguide layer 106. In some embodiments, the silicide layers 504, 506 extend along sidewalls of the second dielectric layer 118. In some embodiments, the silicide layers 504, 506 comprise nickel silicide, tungsten silicide, titanium silicide, or some other suitable material.

FIG. 6 illustrates a cross-sectional view 600 of some embodiments of the integrated chip of FIG. 1 in which waveguide contacts contact the semiconductor waveguide layer 106.

A first waveguide contact 602 is on the first pickup portion 110 and a second waveguide contact 604 is on the second the second pickup portion 112. In some embodiments, the waveguide contacts 602, 604 contact the silicide layers 504, 506, respectively. In some embodiments, the silicide layers 504, 506 are directly between the waveguide contacts 602, 604 and doped regions 406, 408, respectively. In some other embodiments, the waveguide contacts 602, 604 directly contact doped regions 406, 408, respectively. The silicide layers 504, 506 and the doped regions 406, 408 having high doping concentrations reduce the contact resistance between the waveguide contacts 602, 604 and the semiconductor waveguide layer 106.

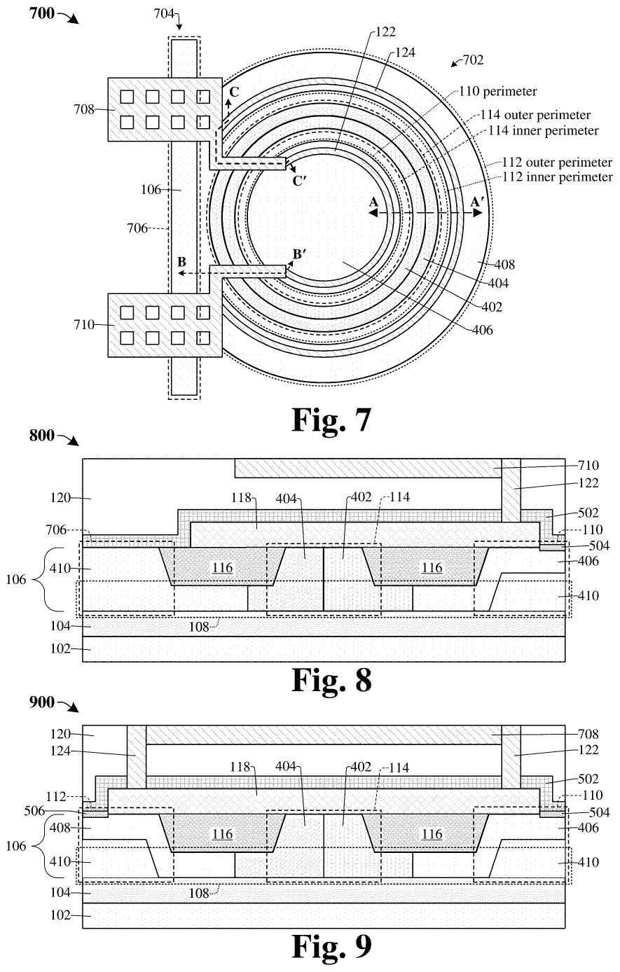

FIG. 7 illustrates a top view 700 of some embodiments of an integrated chip comprising a heater over a waveguide in which the waveguide forms a ring modulator. In some embodiments, cross-sectional view 400 of FIG. 4 is taken across line A-A′ of FIG. 7. The base portion 108, the first dielectric layer 116, the second dielectric layer 118, and the third dielectric layer 120 are not shown in FIG. 7 for clarity of illustration of the semiconductor waveguide layer 106 and the heater.

FIGS. 8-9 illustrate cross-sectional views 800-900 of some embodiment of the integrated chip of FIG. 7. In some embodiments, cross-sectional view 800 of FIG. 8 is taken across line B-B′ of FIG. 7 and cross-sectional view 900 of FIG. 9 is taken across line C-C′ of FIG. 7.

Referring to FIGS. 7-9, the ring modulator includes a ring waveguide 702 and a bus waveguide 704 extending beside the ring waveguide 702. The semiconductor waveguide layer 106 forms the bus waveguide 704 and the ring waveguide 702. The core portion 114 of the semiconductor waveguide layer 106 forms the core of the ring waveguide 702. The first pickup portion 110 is surrounded by the core portion 114. The second pickup portion 112 partially surrounds the core portion 114 and the first pickup portion 110. A second core portion 706 of the semiconductor waveguide layer 106 forms the core of the bus waveguide 704.

The first heat radiator 122 extends in an arc over the first pickup portion 110 along an outer perimeter of the first pickup portion 110. The second heat radiator 124 extends in an arc over the second pickup portion 112 along an inner perimeter of the second pickup portion 112. The first heat radiator 122 and the second heat radiator 124 are coupled in parallel by a first heater electrode 708 and a second heater electrode 710 of the heater. For example, the first heater electrode 708 couples a first end of the first heat radiator 122 to a first end of the second heat radiator 124 and the second heater electrode 710 couples a second end of the first heat radiator 122 to a second end of the second heat radiator 124. By coupling the first heater electrode 708 to a first voltage supply terminal (not shown) and the second heater electrode 710 to a second voltage supply terminal (not shown), a voltage difference can be applied across the heater electrodes 708, 710 to cause current to flow from the first heater electrode 708 to the second heater electrode 710 through the parallelly coupled heat radiators 122, 124, which causes the heat radiators 122, 124 to emit heat. Heat emitted from the heat radiators 122, 124 heats the ring waveguide 702 to control the performance of the ring waveguide 702.

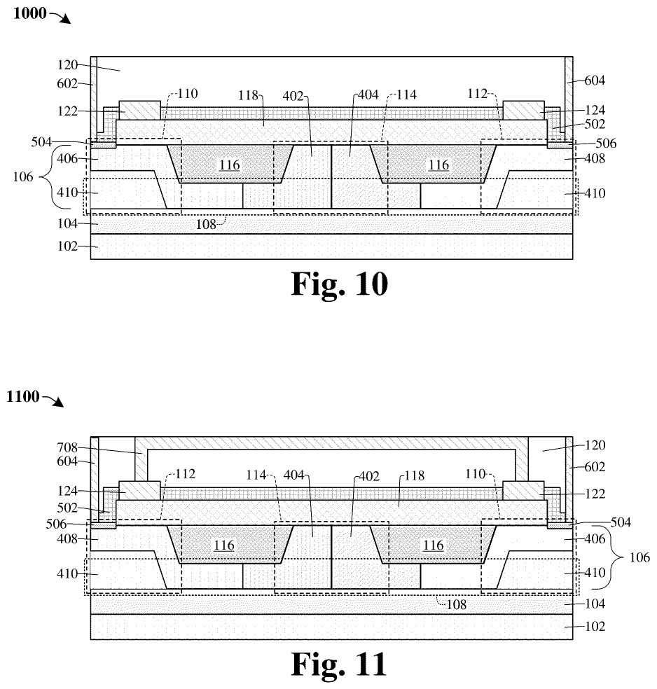

FIGS. 10-11 illustrate cross-sectional views 1000-1100 of some other embodiments of the integrated chip of FIGS. 7-9. In some embodiments, cross-sectional view 1000 of FIG. 10 is taken across line A-A′ of FIG. 7. In some embodiments, cross-sectional view 1100 of FIG. 11 is taken across line C-C′ of FIG. 7.

Referring to FIGS. 10-11, the heat radiators 122, 124 have a plate-like or pad-like structure where the widths of the heat radiators 122, 124 are greater than the heights of the heat radiators 122, 124. The heater electrodes 708, 710 have lateral portions spaced over the heat radiators 122, 124 and have vertical contact portions that extend vertically from the lateral portions to the heat radiators 122, 124 to couple the lateral portions of the heater electrodes 708, 710 to the heat radiators 122, 124. In some cases, by increasing the widths of the heat radiators 122, 124 and thus the surface area of the heat radiators 122, 124 over the pickup portions 110, 112, heat transfer between the heat radiators 122, 124 and the semiconductor waveguide layer 106 can be improved.

In some cases where the heat radiators 122, 124 are coupled in parallel by the heater electrodes 708, 710, the electrical resistance of the heater is higher where the heater electrodes 708, 710 contact the heat radiators 122, 124 than along the parallelly coupled heat radiators 122, 124. Consequently, in such cases, more heat may be emitted at the connections between the heater electrodes 708, 710 and the heat radiators 122, 124 than along the heat radiators 122, 124 themselves. As a result, the efficiency of the heat radiators 122, 124 may be reduced (e.g., more power may be required to increase the temperature of the heat radiators 122, 124). Further, in some cases where the heat radiators 122, 124 are coupled in parallel by the heater electrodes 708, 710, the electrical resistance along the first heat radiator 122 may be different (e.g., less than) the electrical resistance along the second heat radiator 124 because the heat radiators 122, 124 have different lengths (e.g., the length of heat radiator 122 between heater electrode 708 and heater electrode 710 is less than the length of heat radiator 124 between heater electrode 708 and heater electrode 710). Consequently, in such cases, the amount of heat emitted along heat radiator 122 may be different than the amount of heat emitted along heat radiator 124. As a result, a uniformity of the heating may be reduced. Furthermore, in some cases where the heat radiators 122, 124 are coupled in parallel by the heater electrodes 708, 710, it may be difficult to tune the electrical resistance of the heat radiators 122, 124.

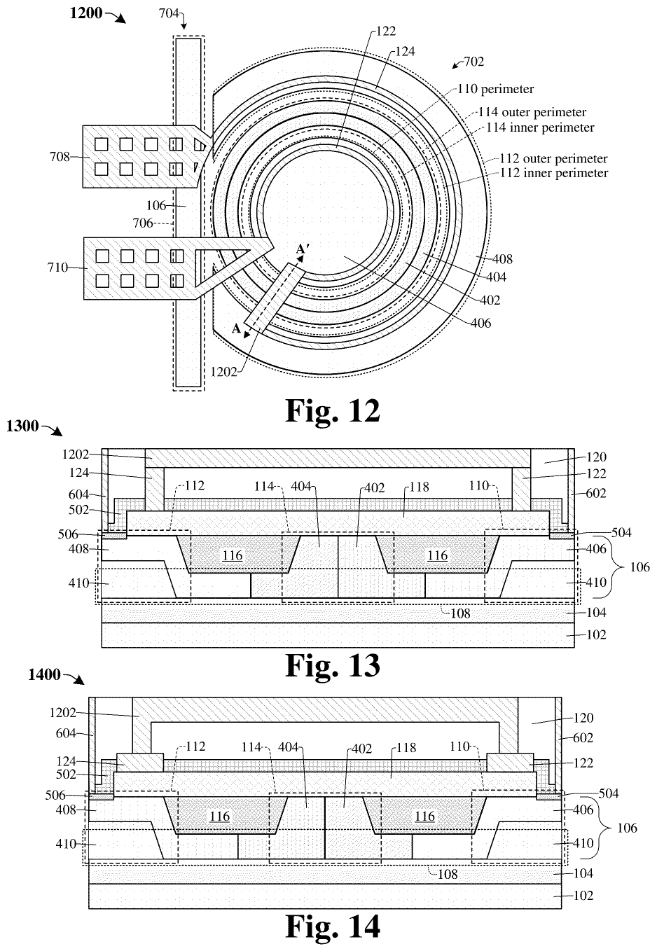

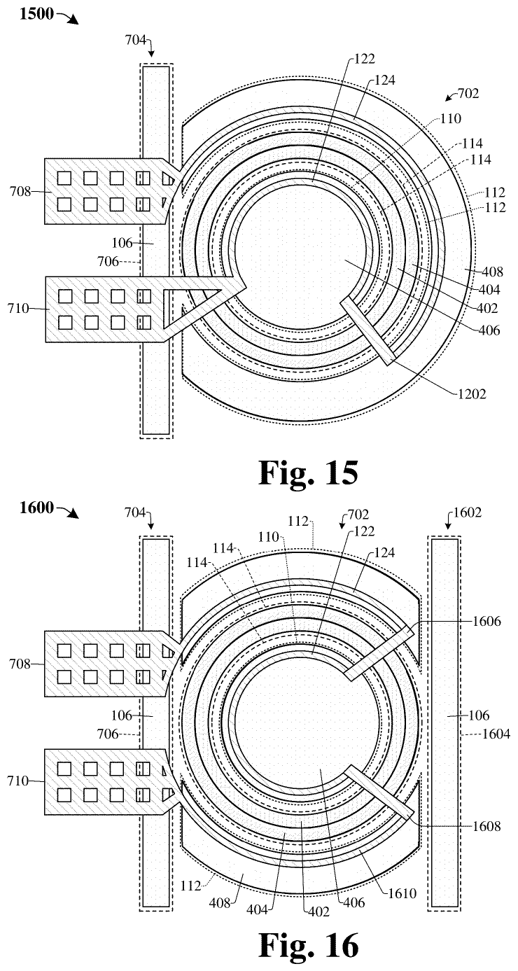

In some embodiments of the present disclosure, the first heat radiator 122 and the second heat radiator 124 are coupled in series between the first heater electrode 708 and the second heater electrode 710 to further improve the performance of the heater. For example, FIG. 12 illustrates a top view 1200 of some embodiments of the integrated chip of FIG. 7 in which the first heat radiator 122 and the second heat radiator 124 are coupled in series between the first heater electrode 708 and the second heater electrode 710. FIG. 13 illustrates a cross-sectional view 1300 of some embodiments of the integrated chip of FIG. 12. In some embodiments, cross-sectional view 1300 of FIG. 13 is taken across line A-A′ of FIG. 12. FIG. 14 illustrates a cross-sectional view 1400 of some other embodiments of the integrated chip of FIG. 12. In some embodiments, cross-sectional view 1400 of FIG. 14 is taken across line A-A′ of FIG. 12. FIG. 15 illustrates a top view 1500 of some other embodiments of the integrated chip of FIG. 12.

Referring to FIGS. 12-15, the first heat radiator 122 and the second heat radiator 124 are coupled in series between the heater electrodes 708, 710 by a heater bridge 1202. For example, a first end of the second heat radiator 124 is coupled to the first heater electrode 708, a second end of the second heat radiator 124 is coupled to a first end of the heater bridge 1202, a first end of the first heat radiator 122 is coupled to a second end of the heater bridge 1202, and a second end of the first heat radiator 122 is coupled to the second heater electrode 710. In some embodiments, the heater bridge 1202 extends laterally between the heat radiators 122, 124, as illustrated in FIG. 13. In some embodiments, the heater bridge 1202 has a lateral portion spaced over the heat radiators 122, 124 and vertical portions extending from the lateral portion to the heat radiators 122, 124, as illustrated in FIG. 14. A voltage difference can be applied across the heater electrodes 708, 710 to cause current to flow from the first heater electrode 708, through heat radiator 124, through heater bridge 1202, through heat radiator 122, to heater electrode 710.

By coupling the heat radiators 122, 124 in series between the heater electrodes 708, 710 with the heater bridge 1202, the efficiency of the heat radiators 122, 124 may be improved (e.g., less power may be required to increase the temperature of the heat radiators 122, 124). Further, by coupling the heat radiators 122, 124 in series between the heater electrodes 708, 710 with the heater bridge 1202, the electrical resistance along the heater has improved uniformity because the current has one path instead of two. Thus, a uniformity of the heating along the heat radiators 122, 124 may be improved. Furthermore, by coupling the heat radiators 122, 124 in series between the heater electrodes 708, 710 with the heater bridge 1202, the electrical resistance of the heat radiators 122, 124 can be more easily tuned by varying the lengths of the heat radiators 122, 124 (and by moving the heater bridge 1202 accordingly). For example, as illustrated in FIG. 15, the lengths of the heat radiators 122, 124 can be adjusted (and the heater bridge 1202 can be moved accordingly) to adjust the electrical resistance of the heater. By tuning the electrical resistance of the heater, the performance (e.g., heat emitted, power consumed, etc.) of the heater can be tuned.

The heater bridge 1202 is spaced over the core portion 114 by a substantial distance so as not to increase the likelihood of causing optical loss along the core portion 114. In some embodiments, the heater bridge 1202 comprises a metal (e.g., tungsten, titanium, copper, or the like), a semiconductor (e.g., polysilicon, silicon, or the like), a silicide, or some other suitable material.

FIG. 16 illustrates a top view 1600 of some other embodiments of the integrated chip of FIG. 12.

The ring modulator includes a second bus waveguide 1602 extending beside the ring waveguide 702 on the opposite side as bus waveguide 704. The semiconductor waveguide layer 106 forms the second bus waveguide 1602. A third core portion 1604 of the semiconductor waveguide layer 106 forms the core of the second bus waveguide 1602.

The heater includes the first heater electrode 708, the second heater electrode 710, the first heat radiator 122, the second heat radiator 124, a third heat radiator 1610, a first heater bridge 1606 and a second heater bridge 1608. A first end of the second heat radiator 124 is coupled to the first heater electrode 708, a second end of the second heat radiator 124 is coupled to a first end of heater bridge 1606, a first end of heat radiator 122 is coupled to a second end of heater bridge 1606, a second end of heat radiator 122 is coupled to a first end of heater bridge 1608, a first end of heat radiator 1610 is coupled to a second end of heater bridge 1608, and a second end of heat radiator 1610 is coupled to heater electrode 710. The two heater bridges 1606, 1608 are included to prevent the heat radiators 122, 124, 1610 from landing on the second bus waveguide 1602. The performance of the heater can be tuned by adjusting the lengths of the heat radiators 122, 124, 1610 and adjusting the positions of the heater bridges 1606, 1608 accordingly.

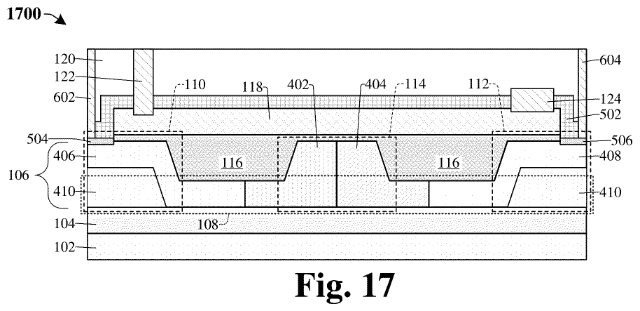

FIG. 17 illustrates a cross-sectional view 1700 of some other embodiments of the integrated chips of FIGS. 1-16.

In some embodiments, the first dielectric layer 116 extends above a top of the semiconductor waveguide layer 106 and directly between the second dielectric layer 118 and portions 110, 112, 114 of the semiconductor waveguide layer 106. In some embodiments, the heat radiators 122, 124 extend into the second dielectric layer 118.

FIGS. 18-34 illustrate cross-sectional views 1800-3400 of some embodiments of a method for forming an integrated chip comprising a heater over a waveguide. Although FIGS. 18-34 are described in relation to a method, it will be appreciated that the structures disclosed in FIGS. 18-34 are not limited to such a method, but instead may stand alone as structures independent of the method.

FIGS. 18-27 illustrate cross-sectional views 1800-2700 of some embodiments of a method for forming a waveguide.

As shown in cross-sectional view 1800 of FIG. 18, a semiconductor waveguide layer 106 is provided. In some embodiments, the semiconductor waveguide layer 106 is formed over the base dielectric layer 104 and the base semiconductor layer 102 by depositing a semiconductor over the base dielectric layer 104 by an epitaxial growth process or some other suitable process. In some other embodiments, the semiconductor waveguide layer 106, the base dielectric layer 104, and the base semiconductor layer 102 are provided as an SOI substrate.

In some embodiments, the semiconductor waveguide layer 106 comprises intrinsic silicon, lightly doped (e.g., p−) silicon, or some other suitable semiconductor. In some embodiments, the base dielectric layer 104 comprises silicon dioxide or some other suitable dielectric. In some embodiments, the base semiconductor layer 102 comprises silicon or some other suitable semiconductor.

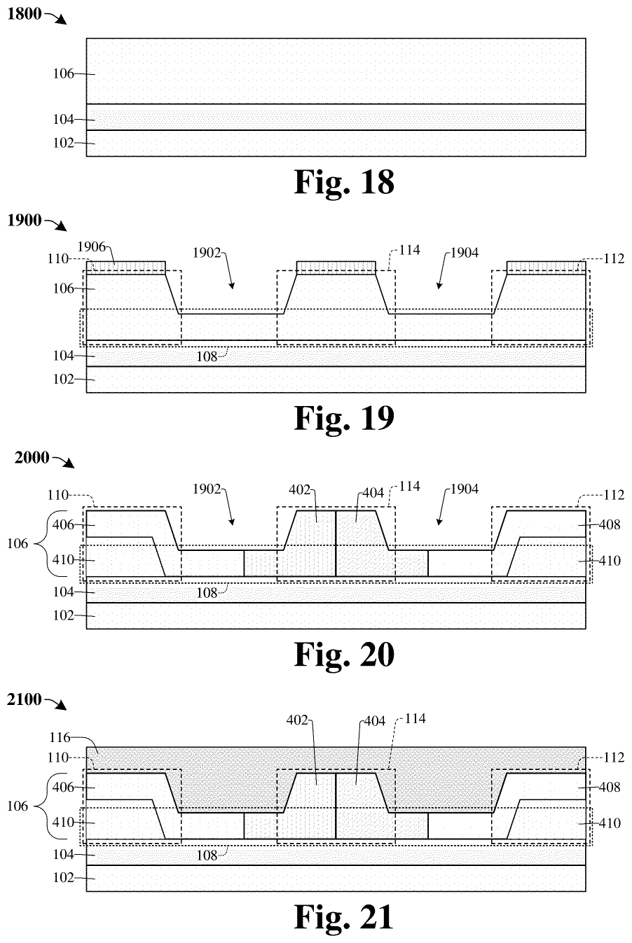

As shown in cross-sectional view 1900 of FIG. 19, the semiconductor waveguide layer 106 is etched to delimit the core portion 114 and the pickup portions 110, 112 over the base portion 108. The etching forms a first trench 1902 and a second trench 1904 laterally spaced apart in the semiconductor waveguide layer 106 to form the core portion 114 and the pickup portions 110, 112 spaced from the core portion 114. The etching extends into the semiconductor waveguide layer 106 but not through the semiconductor waveguide layer 106 so that the base portion 108 remains between the core portion 114 and the pickup portions 110, 112 so that heat can be transferred from the pickup portions 110, 112 to the core portion 114 through the thermally conductive base portion 108.

In some embodiments, a masking layer 1906 is formed over parts of the semiconductor waveguide layer 106 and the etching is performed according to the masking layer 1906. In some embodiments, the etching comprises a dry etching process (e.g., a plasma etching process, a reactive ion etching process, an ion beam etching process, or the like), a wet etching process, or some other suitable process. In some embodiments, a masking layer comprises a photoresist masking layer, a hard masking layer, or some other suitable masking layer.

As shown in cross-sectional view 2000 of FIG. 20, the semiconductor waveguide layer 106 is doped to form doped regions 402, 404, 406, 408 in the semiconductor waveguide layer 106. The first doped region 402 and the third doped region 406 are doped to have a first doping type (e.g., n type). The second doped region 404 and the fourth doped region 408 are doped to have a second doping type (e.g., p type). The third doped region 406 is doped to have a substantially higher doping concentration than the first doped region 402. The fourth doped region 408 is doped to have a substantially higher doping concentration than the second doped region 404. In some embodiments, regions 410 of the semiconductor waveguide layer 106 remain undoped (or maintain whatever doping the semiconductor waveguide layer 106 is originally formed with).

As shown in cross-sectional view 2100 of FIG. 21, a first dielectric layer 116 is deposited over the semiconductor waveguide layer 106. The first dielectric layer 116 fills the first trench 1902 and the second trench 1904. In some embodiments, the first dielectric layer 116 comprises silicon dioxide or some other suitable material and is deposited by a chemical vapor deposition (CVD) process, a physical vapor deposition (PVD) process, an atomic layer deposition (ALD) process, or some other suitable process.

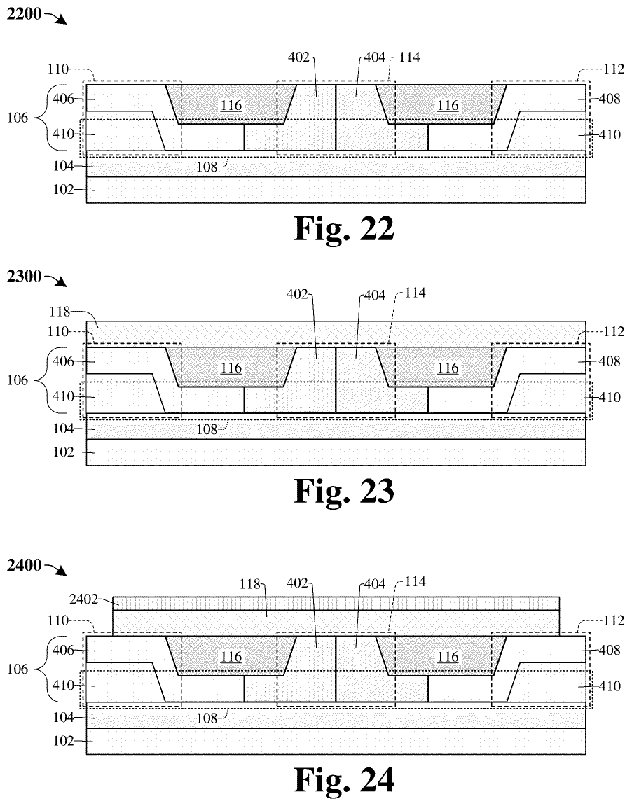

As shown in cross-sectional view 2200 of FIG. 22, the first dielectric layer 116 is removed from over the core portion 114 and the pickup portions 110, 112 of the semiconductor waveguide layer 106. In some embodiments, removing the first dielectric layer 116 from the core portion 114 and the pickup portions 110, 112 comprises performing a planarization process (e.g., a chemical mechanical planarization (CMP) or the like) on the first dielectric layer 116 and the semiconductor waveguide layer 106 so a top of the semiconductor waveguide layer 106 and a top of the first dielectric layer 116 are approximately coplanar. In some other embodiments, removing the first dielectric layer 116 from the core portion 114 and the pickup portions 110, 112 comprises performing a blanket etch back process on the first dielectric layer 116 until the tops of the core portion 114 and the pickup portions 110, 112 are uncovered.

In some embodiments, the first dielectric layer 116 is not completely removed from over the core portion and the pickup portions 110, 112 and thus a portion of the first dielectric layer 116 remains on tops of the core portion 114 and the pickup portions 110, 112, as illustrated in FIG. 17.

As shown in cross-sectional view 2300 of FIG. 23, a second dielectric layer 118 (e.g., a resist protective dielectric layer) is deposited over the semiconductor waveguide layer 106 and the first dielectric layer 116. In some embodiments, the second dielectric layer 118 comprises silicon dioxide, silicon nitride, or some other suitable dielectric and is deposited by a CVD process, a PVD process, an ALD process, or some other suitable process to have a substantially small thickness (e.g., less than about 500 nanometers, ranges from about 1 nanometer to 500 nanometers, or is some other suitable thickness). For example, the second dielectric layer 118 is deposited to have a thickness that is less than a width of the first trench 1902 (less than a distance between the first pickup portion 110 and the core portion 114) and/or less than a width of the second trench 1904 (less than a distance between the second pickup portion 112 and the core portion 114).

As shown in cross-sectional view 2400 of FIG. 24, the second dielectric layer 118 is etched to delimit the second dielectric layer 118. The etching removes the second dielectric layer 118 from over portions of the pickup portions 110, 112. In some embodiments, a masking layer 2402 is formed over parts of the second dielectric layer 118 and the etching is performed according to the masking layer 2402. In some embodiments, the etching comprises a dry etching process, a wet etching process, or some other suitable process.

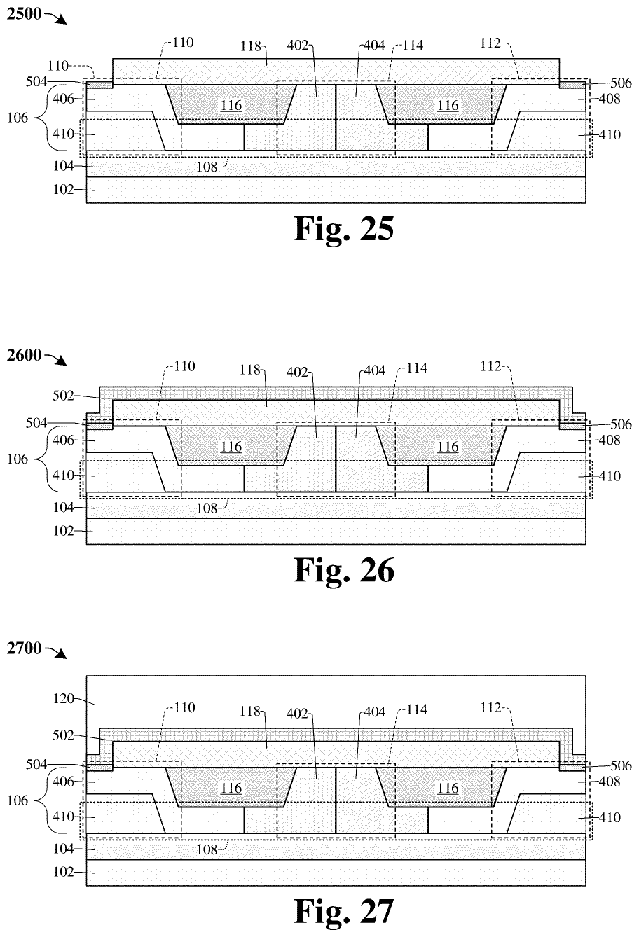

As shown in cross-sectional view 2500 of FIG. 25, a silicide layer 504 is formed along the exposed top of the first pickup portion 110 and a silicide layer 506 is formed along the exposed top of the second pickup portion 112. In some embodiments, the silicide layers 504, 506 are formed by depositing a conductive layer (e.g., a layer comprising nickel, tungsten, titanium, or the like) on the exposed tops of the pickup portions 110, 112, performing a first anneal processes to form the silicide layers 504, 506 from the conductive layer and the semiconductor waveguide layer 106 along the tops of the pickup portions 110, 112, removing remaining conductive layer from over the silicide layers 504, 506 (e.g., by a selective etching process or some other suitable process), and performing a second anneal process to ensure remaining conductive layer is formed into the silicide layers 504, 506.

As shown in cross-sectional view 2600 of FIG. 26, an etch stop layer 502 is conformally deposited over the second dielectric layer 118 and the silicide layers 504, 506. The etch stop layer 502 comprises silicon dioxide, silicon nitride, silicon carbide, a metal oxide (e.g., aluminum oxide or the like), or some other suitable material and is deposited by a CVD process, a PVD process, an ALD process, or some other suitable process.

As shown in cross-sectional view 2700 of FIG. 27, a third dielectric layer 120 (e.g., an interlayer dielectric layer) is deposited over the etch stop layer 502. The third dielectric layer 120 comprises silicon dioxide or some other suitable dielectric and is deposited by a CVD process, a PVD process, an ALD process, or some other suitable process.

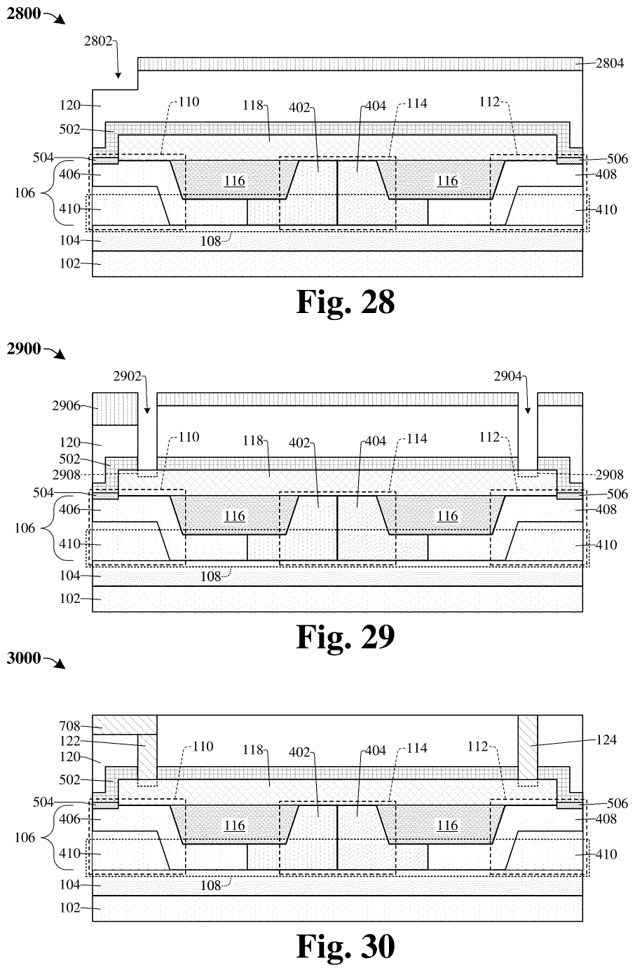

FIGS. 28-31 illustrate cross-sectional views 2800-3100 of some embodiments of a method for forming a heater over the semiconductor waveguide layer 106.

As shown in cross-sectional view 2800 of FIG. 28, the third dielectric layer 120 is etched to form a first heater electrode opening 2802 and a second heater electrode opening (not shown) in the third dielectric layer 120. In some embodiments, a masking layer 2804 is formed over parts of the third dielectric layer 120 and the etching is performed according to the masking layer 2804. In some embodiments, the etching comprises a dry etching process, a wet etching process, or some other suitable process.

As shown in cross-sectional view 2900 of FIG. 29, the third dielectric layer 120 and the etch stop layer 502 are etched to form a first heat radiator opening 2902 and a second heat radiator opening 2904 in the third dielectric layer 120 and the etch stop layer 502. The etching uncovers portions of the second dielectric layer 118. In some embodiments, the heat radiators openings 2902, 2904 both extend from the first heater electrode opening 2802 to the second heater electrode opening (not shown) along separate paths. In some embodiments, the etching extends into the second dielectric layer 118, as illustrated by dashed lines 2908.

In some embodiments, a masking layer 2906 is formed over parts of the third dielectric layer 120 and the etching is performed according to the masking layer 2906. In some embodiments, the etching comprises a first etching process to etch the third dielectric layer 120 and a second etching process to etch the etch stop layer 502 and uncover the second dielectric layer 118. In some embodiments, these etching processes comprise dry etching processes or some other suitable processes.

As shown in cross-sectional view 3000 of FIG. 30, a first heat radiator 122 is formed in the first heat radiator opening 2902, a second heat radiator 124 is formed in the second heat radiator opening 2904, a first heater electrode 708 is formed in the first heater electrode opening 2802, and a second heater electrode (not shown) is formed in the second heater electrode opening (not shown). The heat radiators 122, 124, the first heater electrode 708, and the second heater electrode (not shown) are formed by depositing a metal (e.g., tungsten, titanium, copper, or the like), silicon, a silicide, or some other suitable material in their respective openings by a CVD process, a PVD process, an ALD process, or some other suitable process and subsequently performing a planarization process.

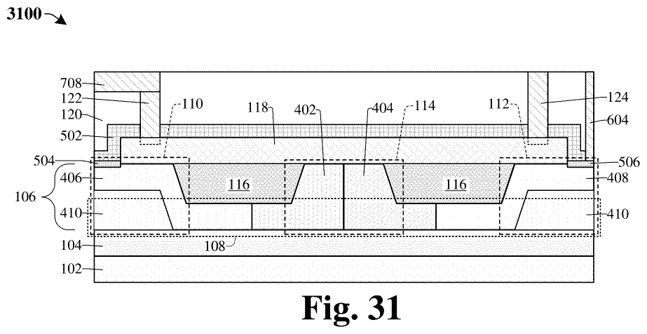

As shown in cross-sectional view 3100 of FIG. 31, a first waveguide contact (not shown) and a second waveguide contact 604 are formed on the silicide layers 504, 506 at the pickup portions 110, 112, respectively. The waveguide contacts are formed by etching the third dielectric layer 120 and the etch stop layer 502 to form openings over the silicide layer, depositing a conductive material (e.g., tungsten, titanium, copper, or the like) in the openings by a CVD process, a PVD process, an ALD process, or some other suitable process, and subsequently performing a planarization process.

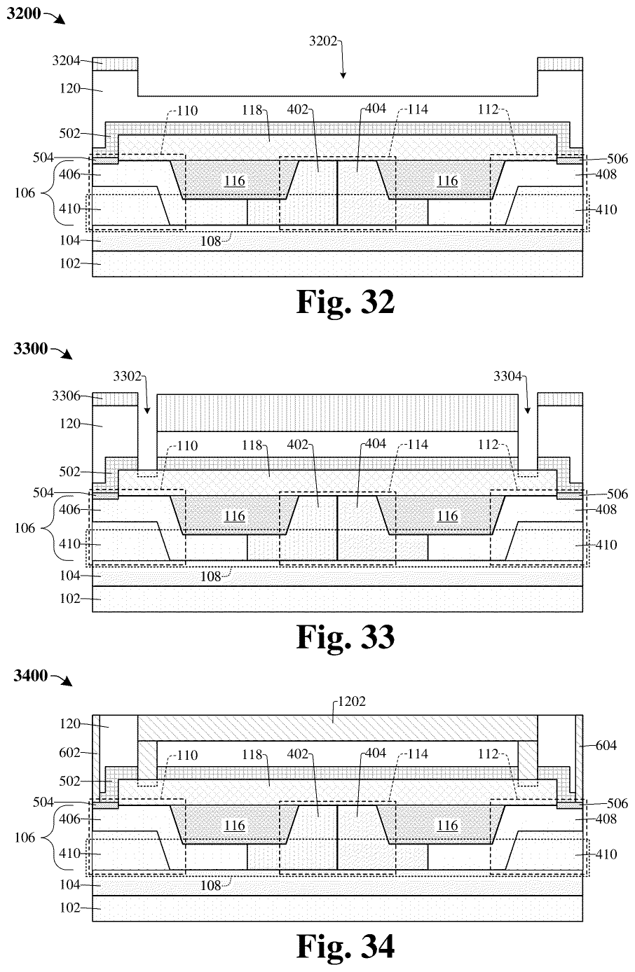

FIGS. 32-34 illustrate cross-sectional views 3200-3400 of some other embodiments of a method for forming a heater over the waveguide.

As shown in cross-sectional view 3200 of FIG. 32, the third dielectric layer 120 is etched to form a heater bridge opening 3202 in the third dielectric layer 120. In some embodiments, a masking layer 3204 is formed over parts of the third dielectric layer 120 and the etching is performed according to the masking layer 3204. In some embodiments, etching forms heater electrode openings (not shown).

As shown in cross-sectional view 3300 of FIG. 33, the third dielectric layer 120 and the etch stop layer 502 are etched to form a first heat radiator opening 3302 and a second heat radiator opening 3304 in the third dielectric layer 120 and the etch stop layer 502. The etching uncovers portions of the second dielectric layer 118. In some embodiments, the etching extends into the second dielectric layer 118. In some embodiments, a masking layer 3306 is formed over parts of the third dielectric layer 120 and the etching is performed according to the masking layer 3306. In some embodiments, the first heat radiator opening 3302 extends from the first heater electrode opening (not shown) to the heater bridge opening 3202 and the second heat radiator opening 3304 extends from the heater bridge opening 3202 to the second heater electrode opening (not shown).

As shown in cross-sectional view 3400 of FIG. 34, heat radiators 122, 124 are formed in the heat radiator openings 3302, 3304, a heater bridge 1202 is formed in the bridge opening 3202, and heater electrodes (not shown) are formed in heater electrode openings (not shown). The heat radiators 122, 124 and the heater bridge 1202 are formed by depositing a metal (e.g., tungsten, titanium, copper, or the like), silicon, a silicide, or some other suitable material in their respective openings by a CVD process, a PVD process, an ALD process, or some other suitable process and subsequently performing a planarization process.

In some embodiments, waveguide contacts 602, 604 are formed on the silicide layers 504, 506 at the pickup portions 110, 112, respectively.

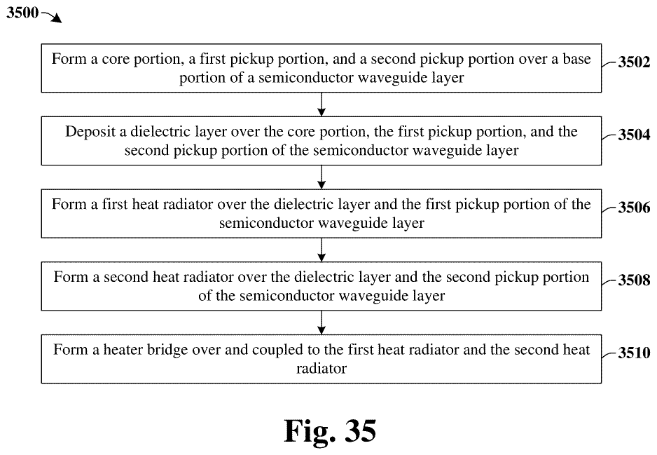

FIG. 35 illustrates a flow diagram of some embodiments of a method 3500 for forming an integrated chip comprising a heater over a waveguide. While method 3500 is illustrated and described below as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the description herein. Further, one or more of the acts depicted herein may be carried out in one or more separate acts and/or phases.

At block 3502, form a core portion, a first pickup portion, and a second pickup portion over a base portion of a semiconductor waveguide layer. FIG. 19 illustrates a cross-sectional view 1900 of some embodiments corresponding to block 3502.

At block 3504, deposit a dielectric layer over the core portion, the first pickup portion, and the second pickup portion of the semiconductor waveguide layer. FIG. 23 illustrates a cross-sectional view 2300 of some embodiments corresponding to block 3504.

At block 3506, form a first heat radiator over the dielectric layer and the first pickup portion of the semiconductor waveguide layer. FIG. 30 illustrates a cross-sectional view 3000 of some embodiments corresponding to block 3506. FIG. 34 illustrates a cross-sectional view 3400 of some other embodiments corresponding to block 3506.

At block 3508, form a second heat radiator over the dielectric layer and the second pickup portion of the semiconductor waveguide layer. FIG. 30 illustrates a cross-sectional view 3000 of some embodiments corresponding to block 3508. FIG. 34 illustrates a cross-sectional view 3400 of some other embodiments corresponding to block 3508.

At block 3510, in some embodiments, form a heater bridge over and coupled to the first heat radiator and the second heat radiator. FIG. 34 illustrates a cross-sectional view 3400 of some embodiments corresponding to block 3510.

Thus, the present disclosure relates to a heater over a waveguide, where a lateral distance between the heater and a core of the waveguide is increased and a vertical distance between the heater and the waveguide is reduced to improve the efficiency of the heater and the reliability of the integrated chip without increasing optical loss at the core.

Accordingly, in some embodiments, the present disclosure relates to an integrated chip including a semiconductor waveguide layer over a substrate. A core portion of the semiconductor waveguide layer protrudes upward from a base portion of the semiconductor waveguide layer. A first heat radiator is spaced over the semiconductor waveguide layer and laterally spaced from the core portion in a first direction. A second heat radiator is spaced over the semiconductor waveguide layer and laterally spaced from the core portion in a second direction, different than the first direction. A first dielectric layer is between the first heat radiator and the semiconductor waveguide layer and between the second heat radiator and the semiconductor waveguide layer. A distance between the first heat radiator and the semiconductor waveguide layer is less than a distance between the first heat radiator and the core portion. A distance between the second heat radiator and the semiconductor waveguide layer is less than a distance between the second heat radiator and the core portion.

In other embodiments, the present disclosure relates to an integrated chip including a semiconductor waveguide layer over a substrate. A first pickup portion of the semiconductor waveguide layer protrudes upward from a base portion of the semiconductor waveguide layer. A second pickup portion of the semiconductor waveguide layer protrudes upward from the base portion and is laterally spaced from the first pickup portion. A core portion of the semiconductor waveguide layer protrudes upward from the base portion and is laterally spaced between the first pickup portion and the second pickup portion. A protective dielectric layer is over the first pickup portion, the second pickup portion, and the core portion. An interlayer dielectric (ILD) layer is over the protective dielectric layer. A first heat radiator and a second heat radiator are within the ILD layer. The first heat radiator is spaced over and separated from the first pickup portion by the protective dielectric layer. The second heat radiator is spaced over and separated from the second pickup portion by the protective dielectric layer.

In yet other embodiments, the present disclosure relates to a method for forming integrated chip. The method includes etching a semiconductor waveguide layer to delimit a first pickup portion of the semiconductor waveguide layer, a second pickup portion of the semiconductor waveguide layer, and a core portion of the semiconductor waveguide layer. The first pickup portion protrudes upward from a base portion of the semiconductor waveguide layer. The second pickup portion of the semiconductor waveguide layer protrudes upward from the base portion and is laterally spaced from the first pickup portion. The core portion of the semiconductor waveguide layer protrudes upward from the base portion and is laterally spaced between the first pickup portion and the second pickup portion. The method includes depositing a first dielectric layer over the first pickup portion, the second pickup portion, and the core portion of the semiconductor waveguide layer. The method includes depositing a second dielectric layer over the first dielectric layer. The method includes etching the second dielectric layer to uncover a first upper surface of the first dielectric layer over the first pickup portion and a second upper surface of the first dielectric layer over the second pickup portion. The method includes forming a first heat radiator on the first upper surface of the first dielectric layer and a second heat radiator on the second upper surface of the first dielectric layer.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An integrated chip comprising:
a semiconductor waveguide layer over a substrate, a core portion of the semiconductor waveguide layer protruding upward from a base portion of the semiconductor waveguide layer;
a first heat radiator spaced over the semiconductor waveguide layer and laterally spaced from the core portion in a first direction;
a second heat radiator spaced over the semiconductor waveguide layer and laterally spaced from the core portion in a second direction, different than the first direction; and
a first dielectric layer between the first heat radiator and the semiconductor waveguide layer and between the second heat radiator and the semiconductor waveguide layer,
wherein a distance between the first heat radiator and the semiconductor waveguide layer is less than a distance between the first heat radiator and the core portion, and wherein a distance between the second heat radiator and the semiconductor waveguide layer is less than a distance between the second heat radiator and the core portion.

2. The integrated chip of claim 1, wherein a first pickup portion of the semiconductor waveguide layer protrudes upward from the base portion and is laterally spaced from the core portion in the first direction, wherein a second pickup portion of the semiconductor waveguide layer protrudes upward from the base portion and is laterally spaced from the core portion in the second direction, and wherein the first heat radiator is directly over the first pickup portion and the second heat radiator is directly over the second pickup portion.

3. The integrated chip of claim 2, wherein a distance between the first heat radiator and the first pickup portion is less than the distance between the first heat radiator and the core portion, and wherein a distance between the second heat radiator and the second pickup portion is less than the distance between the second heat radiator and the core portion.

4. The integrated chip of claim 2, wherein the semiconductor waveguide layer includes a first doped region in the core portion and a second doped region in the core portion and beside the first doped region, wherein the semiconductor waveguide layer includes a third doped region in the first pickup portion and a fourth doped region in the second pickup portion, the first doped region and third doped region having a first doping type, the second doped region and the fourth doped region having a second doping type different than the first doping type.

5. The integrated chip of claim 2, wherein the core portion extends in ring and forms a core of a ring modulator, wherein the first pickup portion is surrounded by the core portion and the second pickup portion partially surrounds the core portion and the first pickup portion, wherein the first heat radiator extends in an arc over the first pickup portion along an outer perimeter of the first pickup portion, and wherein the second heat radiator extends in an arc over the second pickup portion along an inner perimeter of the second pickup portion.

6. The integrated chip of claim 1, further comprising:
a first heater electrode spaced over the semiconductor waveguide layer and extending from the first heat radiator to the second heat radiator; and
a second heater electrode spaced over the semiconductor waveguide layer and extending from the first heat radiator to the second heat radiator,
wherein the first heater electrode and the second heater electrode couple the first heat radiator and the second heat radiator in parallel.

7. The integrated chip of claim 1, further comprising:
a first heater electrode spaced over the semiconductor waveguide layer and coupled to the first heat radiator;
a second heater electrode spaced over the semiconductor waveguide layer and coupled to the second heat radiator; and
a first heater bridge spaced over the semiconductor waveguide layer and extending over the core portion from the first heat radiator to the second heat radiator,
wherein the first heat radiator is coupled in series between the first heater electrode and the first heater bridge, the first heater bridge is coupled in series between the first heat radiator and the second heat radiator, and the second heat radiator is coupled in series between the first heater bridge and the second heater electrode.

8. The integrated chip of claim 7, further comprising:
a third heat radiator spaced over the semiconductor waveguide layer and laterally spaced from the core portion; and
a second heater bridge spaced over the semiconductor waveguide layer and extending over the core portion from the second heat radiator to the third heat radiator,
wherein the second heat radiator is coupled in series between the first heater bridge and the second heater bridge, the second heater bridge is coupled in series between the second heat radiator and the third heat radiator, and the third heat radiator is coupled in series between the second heater bridge and the second heater electrode.

9. An integrated chip comprising:
a semiconductor waveguide layer over a substrate, a first pickup portion of the semiconductor waveguide layer protruding upward from a base portion of the semiconductor waveguide layer, a second pickup portion of the semiconductor waveguide layer protruding upward from the base portion and laterally spaced from the first pickup portion, and a core portion of the semiconductor waveguide layer protruding upward from the base portion and laterally spaced between the first pickup portion and the second pickup portion;
a protective dielectric layer over the first pickup portion, the second pickup portion, and the core portion;
an interlayer dielectric (ILD) layer over the protective dielectric layer; and
a first heat radiator and a second heat radiator within the ILD layer, the first heat radiator spaced over and separated from the first pickup portion by the protective dielectric layer, the second heat radiator spaced over and separated from the second pickup portion by the protective dielectric layer.

10. The integrated chip of claim 9, wherein a thickness of the protective dielectric layer is less than a distance between the first heat radiator and the core portion of the semiconductor waveguide layer.

11. The integrated chip of claim 9, further comprising:
a heater electrode within the ILD layer and spaced over the semiconductor waveguide layer,
wherein heater electrode extends laterally through the ILD layer to the first heat radiator, wherein the first heat radiator extends vertically from a lateral portion of the heater electrode to the protective dielectric layer, and wherein a height of the first heat radiator is greater than a width of the first heat radiator.

12. The integrated chip of claim 9, further comprising:
a heater electrode within the ILD layer and spaced over the semiconductor waveguide layer,
wherein heater electrode extends laterally through the ILD layer and vertically through the ILD layer from a lateral portion of the heater electrode to the first heat radiator, wherein the first heat radiator extends vertically from a vertical portion of the heater electrode to the protective dielectric layer, and wherein a width of the first heat radiator is greater than a height of the first heat radiator.

13. The integrated chip of claim 9, further comprising:
an etch stop layer between the protective dielectric layer and the ILD layer, wherein the first heat radiator and the second heat radiator extend through the etch stop layer to the protective dielectric layer.

14. The integrated chip of claim 9, wherein the first heat radiator and the second heat radiator extend into the protective dielectric layer below a top surface of the protective dielectric layer.

15. A method for forming integrated chip, the method comprising:
etching a semiconductor waveguide layer to delimit a first pickup portion of the semiconductor waveguide layer, a second pickup portion of the semiconductor waveguide layer, and a core portion of the semiconductor waveguide layer, the first pickup portion protruding upward from a base portion of the semiconductor waveguide layer, the second pickup portion of the semiconductor waveguide layer protruding upward from the base portion and laterally spaced from the first pickup portion, and the core portion of the semiconductor waveguide layer protruding upward from the base portion and laterally spaced between the first pickup portion and the second pickup portion;
depositing a first dielectric layer over the first pickup portion, the second pickup portion, and the core portion of the semiconductor waveguide layer;
depositing a second dielectric layer over the first dielectric layer;
etching the second dielectric layer to uncover a first upper surface of the first dielectric layer over the first pickup portion and a second upper surface of the first dielectric layer over the second pickup portion; and
forming a first heat radiator on the first upper surface of the first dielectric layer and a second heat radiator on the second upper surface of the first dielectric layer.

16. The method of claim 15, wherein the first dielectric layer is deposited to have a thickness that is less than a distance between the core portion and the first pickup portion.

17. The method of claim 15, further comprising:
depositing a third dielectric layer between the first pickup portion and the core portion and between the second pickup portion and the core portion, wherein the first dielectric layer is deposited over the third dielectric layer.

18. The method of claim 15, further comprising:
depositing an etch stop layer over the first dielectric layer, wherein the second dielectric layer is deposited over the etch stop layer; and
etching the etch stop layer to uncover the first upper surface and the second upper surface of the first dielectric layer.

19. The method of claim 15, further comprising:
forming a first heater electrode in the second dielectric layer and extending from the first heat radiator to the second heat radiator; and
forming a second heater electrode in the second dielectric layer and extending from the first heat radiator to the second heat radiator,
wherein the first heater electrode and the second heater electrode couple the first heat radiator and the second heat radiator in parallel.

20. The method of claim 15, further comprising:
forming a first heater electrode in the second dielectric layer and coupled to the first heat radiator;
forming a second heater electrode in the second dielectric layer and coupled to the second heat radiator; and
forming a first heater bridge in the second dielectric layer and extending over the core portion from the first heat radiator to the second heat radiator,
wherein the first heat radiator is coupled in series between the first heater electrode and the first heater bridge, the first heater bridge is coupled in series between the first heat radiator and the second heat radiator, and the second heat radiator is coupled in series between the first heater bridge and the second heater electrode.
